(19) United States
(12) Patent Application Publication
(10) Pub. No.: US 2011/0176801 A1
(43) Pub. Date: Jul. 21, 2011

(54) TRANSMISSION UNIT, OPTICAL TRANSMISSION APPARATUS, COMMUNICATION CONTROL METHOD AND PROGRAM STORAGE MEDIUM

(76) Inventor: YUTAKA YANO, Tokyo (JP)

(21) Appl. No.: 13/004,990

(22) Filed: Jan. 12, 2011

(30) Foreign Application Priority Data
Jan. 18, 2010 (JP) 8386/2010

(51) Int. Cl. H04B 10/08

(52) U.S. Cl. 398/30

(57) ABSTRACT

A transmission unit of this application includes a transmission unit, operating in one of modes including a normal communication mode and a connection confirmation mode, wherein the transmission unit transmits, in the normal communication mode, an OSC (Optical Supervisory Channel) signal with time average power beyond predetermined upper limit power; and wherein the transmission unit transmits, in the connection confirmation mode, the OSC signal with time average power lower than the upper limit power and with a transmission rate lower than a transmission rate in the normal communication mode.

This application is based upon and claims the benefit of priority from Japanese Patent Application No. 2010-008386, filed on Jan. 18, 2010, the disclosure of which is incorporated herein in its entirety by reference.

### TECHNICAL FIELD

The present invention relates to communication control in an optical transmission system, and, more particularly, to a transmission unit, an optical transmission apparatus, a communication control method and a program storage medium with program having a function to change transmission power of an OSC (Optical Supervisory Channel) signal in APR (Automatic Power Reduction) function.

### BACKGROUND ART

### Laser Safety Standard

A safety standard has been established because a high power laser beam has a risk to damage a human body, an eye in particular. Specifically, IEC60825-1 of International Electrotechnical Commission (IEC) is a standard which is considered as the base worldwide.

The safety standard of a laser beam has been classified and specified in a complicated and wide-ranging manner according to various conditions and parameters. Hereinafter, limiting to an optical transmission apparatus of 1.55 micrometer band which has a single mode fiber as a transmission medium and which is related to the present invention, the outline of the standard is described.

An optical power range which is regarded as problem-free even if light keeps being radiated from an end face of an optical fiber is class 1 (less than or equal to 10 mW), and some sort of protection measures are required for optical power exceeding class 1. The safety standard described here is not applied on the condition that optical power is shut in an optical fiber and is never in the free radiation state. However, because, in reality, an optical transmission apparatus generally handles optical power exceeding class 1, a protection measure is an important issue for an optical transmission apparatus.

(Automatic Power Reduction (APR))

If optical power exceeding class 1 is being handled in an optical transmission apparatus, there are no problems as long as the optical power is closed in the optical transmission apparatus or in an optical fiber. However, in an optical transmission apparatus, there exists a part where light can be in the free radiation state due to an accident such as cut of an optical fiber or disengagement of an optical connector. In a case where high-power light exceeding class 1 passes a transmission line in such part, a mechanism to detect disconnection of a transmission line, and then, suspend transmission of light or lower transmission level of light to the power level lower than class 1 is required for an optical transmission apparatus.

As a mechanism mentioned above, automatic control which is called APR (Automatic Power Reduction) which detects disconnection of a transmission line and lowers transmission power to a safe level is being used widely.

In automatic control using APR, it is usual to have the function to make a communication system return to the normal state automatically when connection of a transmission line is recovered. In order to realize such function, in this automatic control, without suspending transmission signals completely when a transmission line is disconnected, keeping transmitting a signal with sufficiently low time average power of a level free from a safety problem is necessary for detection of connection recovery. Such technology is recommended in ITU-T (International Telecommunication Union Telecommunication Standardization Sector) Recommendation G.664 as a function that an optical transmission system should have normally.

ITU-T Recommendation G.664 has recommended as an automatic restoration method a method that uses “light signal which is suspended in the state where an optical fiber is broken physically, and which does not require a dangerous power level even at a normal time of operation”, which is referred to as OAC (optical auxiliary channel).

Also, ITU-T Recommendation G.664 discloses that OSC (Optical Supervisory Channel) can be one of exemplary embodiments of OAC. By OSC, it becomes possible to detect restoration of line disconnection as a result of keeping transmitting a signal constantly within the range of transmission power lowered by APR even in the state where a transmission line is broken physically. When restoration of a transmission line is detected, OSC cancels the APR state. That is, when restoration of the transmission line is detected, OSC realizes automatic restoration by resuming transmission of a main signal.

An existing bidirectional optical communication system equipped with the above-mentioned APR function has the following structure. In an optical communication system, a main signal and a supervising channel (OSC line) are usually transmitted in a manner they are multiplexed. The time average value of total transmission power of a transmitted light signal usually exceeds the free radiation upper limit (10 mW at 1.55 micrometer Band) set by the laser safety standard. When disruption of communication is detected in a receiving end, it is controlled through a supervising channel such that the time average value of transmission power of the upstream side falls within the free radiation restriction of the safety standard. Further, a transmitter of a light signal keeps transmitting a signal for detecting a communication recovery in the range of the permitted power. When the receiver of a light signal detects the connection being restored by line recovery work, the communication is recovered automatically by raising the time average value of transmission power in the upstream side to the normal level through a supervising channel.

However, in the above-mentioned related technology, by a reason such as an extremely long distance between stations, there is a case where transmission loss (an attenuation of the signal) between the stations is very large. In order to overcome such problem that a loss in a transmission section is large, optical communication systems have introduced an optical amplifier. In order to make possible to transmit under a further larger loss, an optical communication system has introduced optical amplifiers with larger gain.

In relation to the present application, Japanese Patent Application Laid-Open No. 1999-275014 describes an optical fiber connection checking method between an optical transmitter and a receiver. Japanese Patent Application Laid-Open No. 2000-286798 describes an optical communication system equipped with a supervising channel. Japanese Patent Application Laid-Open No. 2000-244410 describes an optical space communication device in which a sinusoidal signal is superposed as a pilot signal. Japanese Patent Application Laid-Open No. 2000-228639 describes a method to restart an optical transmission apparatus automatically. Further, Japanese Patent Application Laid-Open No. 2007-019677 describes a receiver using synchronous detection.

While the performance of an optical transmission apparatus has been improved by introduction of an optical amplifier, a problem that the arrival limit of a supervising channel (OSC line) restricts an allowable loss between to stations has been formed. The reason of this is that an OSC line needs to keep transmitting a signal even at the time of line disconnection in order to make a system return automatically from a failure, and thus transmission power of the OSC line is restricted in the range of power where free radiation is permitted. Because the information transmission rate of an OSC line is much lower than that of a main signal, required reception power is allowed to be much lower than that of a main signal, and thus, in the related technology before introduction of an optical amplifier, low transmission power has not been a problem.

When transmission power of an OSC signal is increased by an optical amplifier in order to extend the reach of an OSC line in the above-mentioned state, transmission power at the time of line disconnection needs to be lowered to a safe transmission level for free radiation. However, the transmission distance of an OSC signal becomes short by lowering the transmission level of the OSC signal. As a result, even if the line is restored, an opposing optical transmission apparatus cannot receive an OSC signal, and a system may not be recovered automatically.

### SUMMARY

An exemplary object of the invention is to provide a transmission unit, an optical transmission apparatus, a communication control method and a recording medium with a program which satisfy both of realization of a long distance OSC line and safety to a high-power laser beam thereof.

A transmission unit of this application includes a transmission unit, operating in one of modes including a normal communication mode and a connection confirmation mode, wherein the transmission unit transmits, in the normal communication mode, an OSC (Optical Supervisory Channel) signal with time average power beyond predetermined upper limit power; and wherein the transmission unit transmits, in the connection confirmation mode, the OSC signal with time average power lower than the upper limit power and with a transmission rate lower than a transmission rate in the normal communication mode.

An OSC transmission method of this application includes the steps of transmitting, in a normal communication mode, an OSC signal with time average power beyond predetermined upper limit power; and transmitting, in a connection confirmation mode, the OSC signal with time average power lower than the upper limit power and with a transmission rate lower than a transmission rate in the normal communication mode.

A communication control method of this application includes the steps of controlling, in a normal communication mode, a transmission unit such that an OSC signal is transmitted with time average power beyond predetermined upper limit power; and controlling, in a connection confirmation mode, the transmission unit such that the OSC signal is transmitted with time average power lower than the predetermined upper limit power and with a transmission rate lower than a transmission rate in the normal communication mode.

A tangible computer-readable program storage medium of this application tangibly embodies a program of a control unit for making a computer of the control unit operating in one of modes including a normal communication mode and a connection confirmation mode carry out processing of: controlling, in the normal communication mode, a transmission unit such that an OSC signal is transmitted with time average power beyond predetermined upper limit power; and controlling, in the connection confirmation mode, the transmission unit such that the OSC signal is transmitted with time average power lower than the predetermined upper limit power and with a transmission rate lower than a transmission rate in the normal communication mode.

### BRIEF DESCRIPTION OF THE DRAWINGS

Exemplary features and advantages of the present invention will become apparent from the following detailed description when taken with the accompanying drawings in which:

FIG. 1 is a block diagram showing a configuration of an optical transmission apparatus in a first embodiment of the present invention;

FIG. 2 is a diagram showing a configuration and operation of an optical transmission system to which an optical transmission apparatus in the first embodiment has been applied;

FIG. 3 is a diagram showing a configuration and operation of an optical transmission system to which an optical transmission apparatus in the first embodiment has been applied;

FIG. 4 is a diagram showing a configuration and operation of an optical transmission system to which an optical transmission apparatus in the first embodiment has been applied;

FIG. 5 is a diagram showing a configuration and operation of an optical transmission system to which an optical transmission apparatus in the first embodiment has been applied;

FIG. 6 is a diagram showing a configuration and operation of an optical transmission system to which an optical transmission apparatus in the first embodiment has been applied;

FIG. 7 is a diagram showing a configuration and operation of an optical transmission system to which an optical transmission apparatus in the first embodiment has been applied;

FIG. 8 is a diagram showing a configuration and operation of an optical transmission system to which an optical transmission apparatus in the first embodiment has been applied;

FIG. 9 is a diagram showing an exemplary configuration of a sliding type correlation detector in a second embodiment;

FIG. 10 is a diagram showing an exemplary configuration of a matched filter type correlation detector in the second embodiment;

FIG. 11A is a diagram showing a state of a memory store of a correlation detector in the second embodiment; and

FIG. 11B is a diagram showing a state of a memory store of a correlation detector in the second embodiment.

### EXEMPLARY EMBODIMENT

Next, embodiments of the present invention will be described in detail with reference to the drawings.

### The First Embodiment

Generally, the narrower a bandwidth for an optical receiver is, the higher the sensitivity of the optical receiver becomes. The reason of this is that the narrower the bandwidth is, the more noises can be cut off. On the other hand, when the bandwidth is narrowed, there occurs a problem that a transmission rate is limited accordingly.

According to this embodiment, the present invention is applied to an OSC transmitter and an OSC receiver which confirm the connection mutually before entering in the usual communication state.

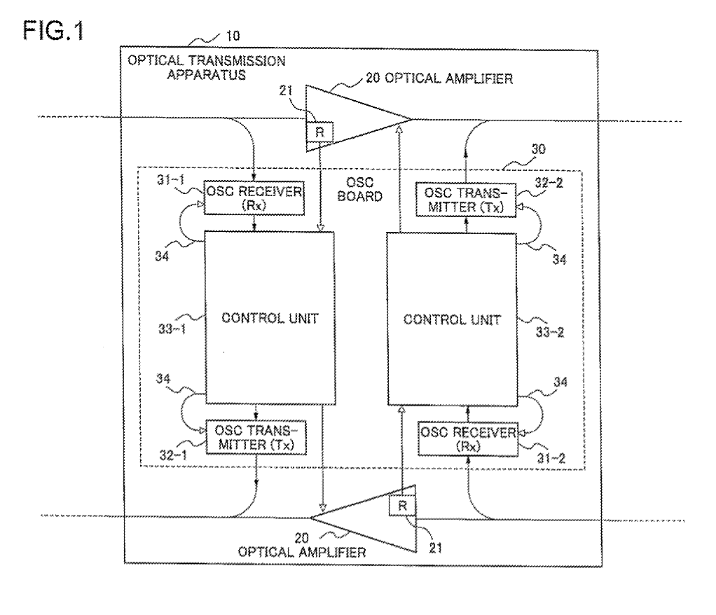

FIG. 1 is a block diagram showing a configuration of an optical transmission apparatus according to this embodiment.

Referring to FIG. 1, an optical transmission apparatus 10 includes an optical amplifier 20 and an OSC board 30.

The optical amplifier 20 amplifies a main signal and an OSC signal. The optical amplifier 20 is provided with a reception monitor 21 (“R” in the figure) for a main signal in its interior, and monitor output of the reception monitor 21 is transmitted to a control unit 33-1 or a control unit 33-2. Meanwhile, an existing optical amplifier can be used as the optical amplifier 20. Because the structure of the optical amplifier 20 is not related to the essence of the present invention, a description about its detail will be omitted.

The OSC board 30 includes OSC receivers 31-1, 31-2 which receive an OSC signal, OSC transmitters 32-1, 32-2 which transmit an OSC signal and the control units 33-1, 33-2. Meanwhile, Tx and Rx in the figure indicate a transmitter and a receiver, respectively. Here, the OSC receivers (31-1, 31-2), the OSC transmitters (32-1, 32-2) and the control units (33-1, 33-2) have a similar structure and a function, respectively. Hereinafter, when collectively called, they are described as an OSC receiver 31, an OSC transmitter 32 and a control unit 33, respectively.

To the OSC receiver 31, a control line 34 for changing a reception mode is connected from the control unit 33 in addition to connections for delivering an OSC signal.

To the OSC transmitter 32, the control line 34 for increasing and to decreasing transmission power is connected from the control unit 33 in addition to connections for delivering an OSC signal.

Meanwhile, when it is difficult to change transmission codes of the OSC transmitter 32 or to make receiving bands of the OSC receiver 31 be variable, two systems of the OSC transmitter 32 and the OSC receiver 31 may be prepared to change the systems according to need.

The control unit 33 has the function to output a signal which controls transmission of a light signal of the optical amplifier 20. When both of the OSC receiver 31 and the reception monitor 21 detect that “a received signal is existing”, the control unit 33 permits the optical amplifier 20 to output optical signal. While two separated control units are employed in this embodiment, the number of control units are not limited to two. For example, a merged single control unit may be employed.

After permitting the optical amplifier 20 to output optical signal, when only the OSC receiver 31 becomes the “no received signal is existing” state, the control unit 33 holds previous states and the operation is continued. However, because this operation is not related to the present invention, a detailed description is omitted.

The control unit 33 has the function to change a mode of an OSC line. The mode of the OSC line includes a normal communication mode and a connection confirmation mode. The control unit 33 switches the current mode from the normal communication mode to the connection confirmation mode at the time of a transmission line failure, and switches the mode from the connection confirmation mode to the normal communication mode at the time of failure recovery.

In the normal communication mode, the control unit 33 sets transmission power of the OSC transmitter 32 to time average power beyond the upper limit value of the laser safety standard to transmit an OSC signal.

In the connection confirmation mode, the control unit 33 sets transmission power of the OSC transmitter 32 to time average power lower than the upper limit power (safety standard value) of the laser safety standard to transmit an OSC signal. The control unit 33 narrows a receiving band of the OSC receiver 31 as much as possible within a range where the OSC signal which transmission power has been set below the safety standard value can be received. That is, the control unit 33 raises the receiving sensitivity of the OSC receiver 31 to a level that the OSC signal concerned can be received. For example, the specific safety standard upper limit value in the 1.55 micrometer band is 10 mW.

Meanwhile, when a connection confirmation signal (an OSC signal in the connection confirmation mode) is detected, the optical transmission apparatus 10 informs that the connection confirmation signal has been detected to the sending end of the connection confirmation signal and confirms the establishment of a bidirectional link. Description of a flow of confirmation of the establishment of a bidirectional link will be made later in the second embodiment of the present invention.

### Description of Operation of the First Embodiment

Next, operation of this embodiment will be described in detail with reference to the drawings.

(Description of Operation of OSC Line)

First, operation of the connection confirmation mode in this embodiment will be described in detail. As an example, an optical transmission system having an inter-station loss of 50 dB will be considered.

In the normal communication mode, the OSC transmitter 32 transmits an OSC signal with transmission power of +16 dBm by a means of such as using an optical amplifier. In the normal communication mode, an information transmission rate and a code of the OSC signal are 155 Mb/s and a NRZ code, and a receiving band is 110 MHz and allowable lowest reception power is −40 dBm. Because transmission power is +16 dBm, a loss budget will be 56 dB and a link loss of 50 dB is admissible sufficiently.

In the connection confirmation mode, transmission power of the OSC transmitter 32 needs to be equal to or less than +10 dBm (10 mW). It is supposed that transmission power of the OSC transmitter 32 is +6 dBm in this exemplary embodiment. In the connection confirmation mode, the information transmission rate of an OSC signal is 4 Mb/s, the receiving band is 3.5 MHz and allowable lowest receiving light power is −50 dBm. Even if transmission power is +6 dBm, a loss budget is 56 dB, and in the case of a link loss of 50 dB, an OSC signal can be received sufficiently at a receiving end. Further, when an OSC signal is transmitted using a short pulse, the receiving band can be made narrow down to about 2 MHz. By making the receiving band narrower, the lowest limit receiving light power can be lowered further.

According to this embodiment, in the normal communication mode, in order to realize a high-speed information transmission rate, an optical transmission apparatus which transmits an OSC signal transmits the OSC signal with high power. Then, an optical transmission apparatus which receives an OSC signal receives the OSC signal with a broadband receiver.

In contrast, in the connection confirmation mode, an optical transmission apparatus which transmits an OSC signal needs to lower transmission power of an OSC signal below the safety standard value. For this reason, an optical transmission apparatus which transmits an OSC signal makes the transmission rate be low-speed to transmit an OSC signal. At the same time, an optical transmission apparatus which receives an OSC signal narrows the receiving bandwidth to make possible to receive the OSC signal even when received power is low. Further, when an optical transmission apparatus which transmits an OSC signal transmits an OSC signal while lowering the pulse duty factor in parallel with lowering the transmission rate, it is possible to narrow the receiving band (low pass filter band) further, and lower required reception power further.

In addition, when the width of a transmission pulse of an OSC signal is narrowed further considerably compared with the symbol width (to less than ½), the receiving band (low pass filter band) of a receiver can be made narrow further. Note that even if a pulse is made short, time average power does not need to be raised.

### Effect of the First Embodiment

Next, the effect of this embodiment will be described.

According to this embodiment, an optical transmission apparatus can transmit a high-power OSC signal in a signal monitoring mode in normal times, and thus it is possible to lengthen an OSC line.

Also according to this embodiment, it is arranged such that, in the time of a transmission line failure, by narrowing the receiving bandwidth of an optical transmission apparatus which receives an OSC signal, an OSC signal can be received even when the received power is low. As a result, an optical transmission apparatus which transmits an OSC signal can make the transmission power of an OSC signal low. For this reason, it becomes possible to lower transmission power of an OSC signal at the time of a transmission line failure to a level not exceeding the regulation value.

In addition, when an optical transmission apparatus transmits an OSC signal while lowering the pulse duty factor as well as lowering the transmission rate, it is possible to narrow the receiving band further, and lower reception power required for reception of an OSC signal further.

### The Second Embodiment

Next, the second embodiment of the present invention will be described in detail with reference to drawings.

In the method for realizing high sensitivity by narrowing a receiving band described in the first embodiment, there is a case where the receiving sensitivity is not improved greatly even if the receiving band is narrowed. Accordingly, in the second embodiment, the technique of lock-in detection (synchronous detection) is introduced into the first embodiment.

In a configuration in which synchronous detection is introduced, at the transmission end of an OSC signal, an OSC signal formed by a short pulse is transmitted with a transmission rate lower than that of the normal communication state. Then, at the receiving end of an OSC signal, a received signal is detected sensitively by performing synchronous detection (lock-in detection) to the received signal using an inner oscillator to transmit the signal. In the technique of the synchronous detection, a received waveform is measured by a sampling clock in which, although its frequency is almost the same as that of the transmission clock of the OSC transmitter 32, their phases are noncorrelated. A transmission code is presumed by finding the feature of the code pattern by accumulating a measured value in a memory corresponding to the length of the code pattern.

In synchronous detection, oscillators with a frequency synchronized between a transmitter and a receiver are usually used. However, because a transmitter and a receiver are located in distant two spots, the frequencies of the oscillators are not easy to be synchronized between the transmitter and the receiver. On the other hand, when the frequency is sufficiently low, an oscillator with a sufficiently stable frequency compared with a code length can be obtained inexpensively. Accordingly, the phase of a code pattern is identified between a transmitter and a receiver using such oscillator. For that purpose, a correlation detector (correlator) is used at a receiving end.

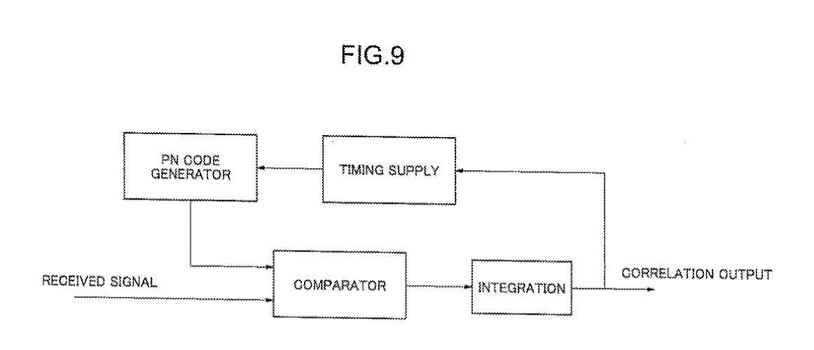

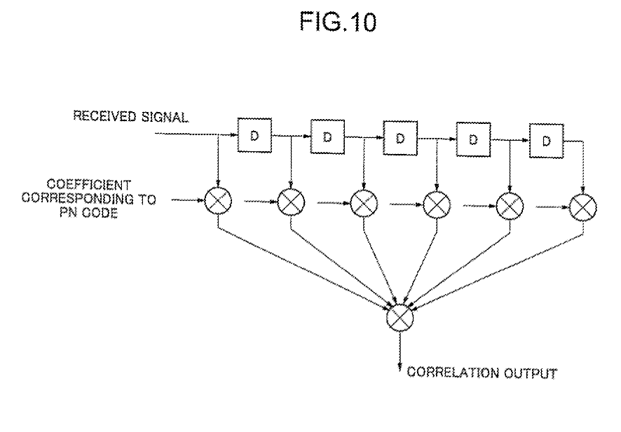

A well known structure as a correlation detector includes a sliding type as shown in FIG. 9 and a matched filter type as shown in FIG. 10.

The sliding type correlator shown in FIG. 9 compares a received signal and output of a PN code generator and outputs its comparison result as a correlation output. A timing supply circuit keeps shifting start timing of a PN code pattern by 1 bit until a high correlation value emerges in correlation output.

A matched filter type correlator shown in FIG. 10 multiplies a bit string of a received signal by a coefficient corresponding to a PN code and outputs the summation of the results as correlation output.

### Description of Operation of the Second Embodiment

Next, operation of this embodiment will be described in detail.

In the connection confirmation mode of this embodiment, a low transmission rate does not matter. Accordingly, the following structure can be realized.

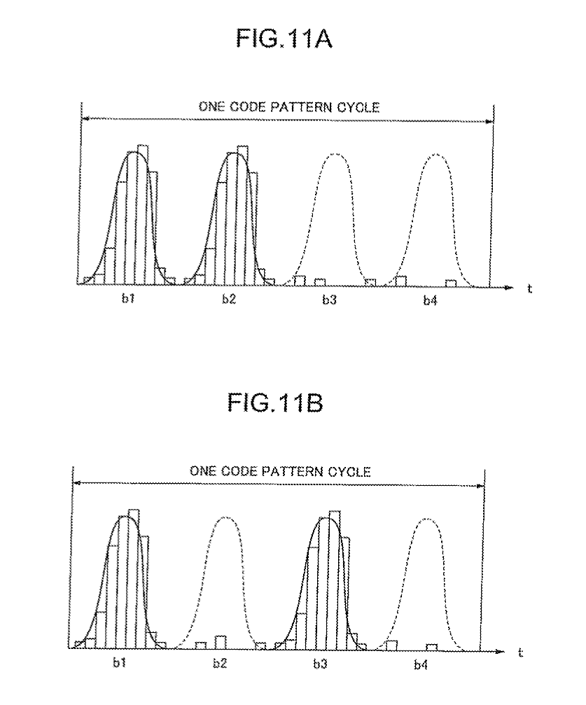

A correlation detector performs AD (analog to digital) conversion of amplitude of a received signal, and stores the result into a memory. The memory has bins corresponding to the number of bits included in one code of a transmission pattern or to about several times of this number, and stores values of amplitudes obtained from received signals while accumulating them in turn. On the occasion of actual storing, it performs storing in a manner it takes a moving average with a previous value. This is shown in FIG. 11A and the FIG. 11B. FIG. 11A shows a case where a code is “1100”, and FIG. 11B shows a case where a code is “1010”.

Here, it is arranged such that existence of a signal is detected more certainly by transmitting two codes of 4-bits codes “1100” and “1010” repeatedly and alternating them at a predetermined interval.

When a received signal is stored up to the last one of the bins, a correlation detector returns to the first bin of the bins and continues storing. Although FIG. 11A and FIG. 11B are drawn from a break of a code pattern for simplification of the description, in reality, the break of the code cannot be recognized until the code pattern is detected. However, it becomes possible to find a code pattern by keeping accumulating and storing.

The positions of bins in a code pattern bring an effect corresponding to synchronous detection. When comparing bins with a transmission pulse and bins without a transmission pulse, a significant correlation peak emerges around bins with the pulse by an averaging processing, and by this, the phase of a code pattern is detected. In this way, even a signal which has been buried in noises can also be detected by using a correlation detector.

By taking a measuring period of several times of a code pattern cycle and, at the same time, by increasing the number of accumulated samples sufficiently, possibility of miscount caused by leaking out of a distribution of the data to bins in the left and right can be reduced. Accordingly, tolerance against a phase noise of an oscillator in a transmitter and a receiver can be increased.

When a moving average is taken for a period longer than an alternation time of the two codes, the height of bins corresponding to a bit the value of which changes according to a code pattern (b2, b3 in FIG. 11A and FIG. 11B) will be half of the height of bins of a bit the value of which exists constantly (b1 in FIG. 11A and FIG. 11B). Therefore, an accumulated value of a bin may be initialized to zero in a cycle of code alternation decided in advance. In this case, because, when the phases of the code alternation cycle become identical at a sending and a receiving end, the heights of the bins of a bit which changes and a bit which exists constantly become identical, a receiver can find the most suitable bin initialization timing using this as a guideline. Search of this most suitable bin initialization timing may be achieved by a single search like a mountain climbing method or may be realized by copying data in a plurality of search devices and comparing results which have been obtained by initializing at different initialization timing in parallel. For example, 10 search devices may be used which have different initialization timing shifting by one tenth of the alternation cycle from its most adjacent counterpart(s) in terms of initialization timing. Then, the search time can be reduced as much as a degree of parallelization.

When a moving average for a period longer than the alternation time of two codes is taken, noises which have no relation with a transmission code are seen as the height of a bin corresponding to a bit the value of which does not exist constantly (b4 of FIG. 11A and FIG. 11B). For this reason, a threshold value for detecting synchronization may be optimized according to the amount of noises. In other words, the rest which is obtained by deducting a value corresponding to the noises from the accumulated value of a bin is regarded as effective correlation data. By this, when noise is small, because synchronization can be determined by short time accumulation, synchronization time can be reduced. In contrast, when there is much noise, by setting the accumulation time rather long and waiting until a bin accumulation value becomes sufficiently high, false detection can be reduced although the synchronization time becomes long.

Because a low speed is acceptable for such data processing, it can be realized by a program-type implementation form of a microcomputer and a FPGA (Field Programmable Gate Array) without preparing special hardware.

Thus, for the correlation processing (lock-in detection), processing for receiving repeat data of a number of times is needed. In the connection confirmation mode, such transmission is possible.

When a connection confirmation signal is detected, the receiving end of the OSC signal informs the sending end about it and confirms establishment of a bidirectional link. This state is described in the description of a link establishment procedure mentioned later.

### Link Establishment Procedure

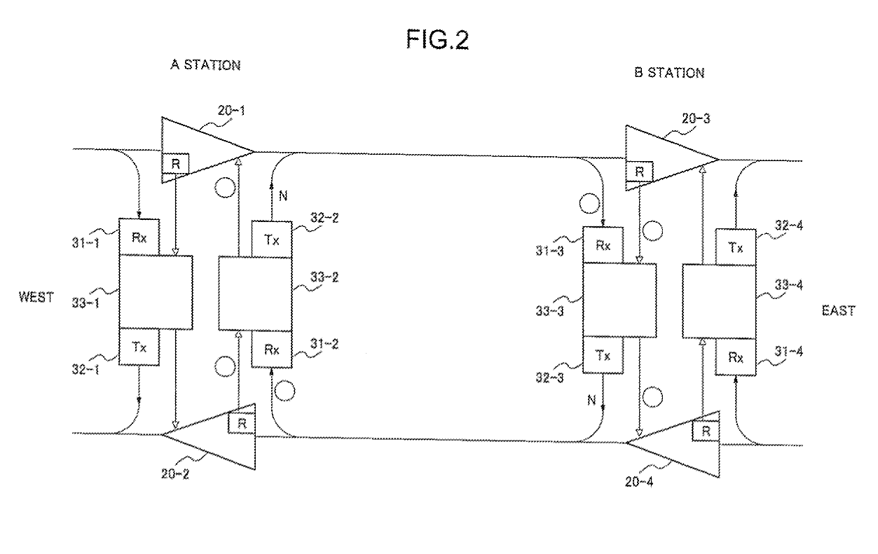

Next, a flow of confirmation of establishment of a bidirectional link will be described using FIGS. 2-8. FIGS. 2-8 are diagrams showing operation of an optical transmission system to which an optical transmission apparatus according to this embodiment is applied. Meanwhile, FIGS. 2-8 are similar in terms of structure, and a similar reference sign is assigned to a similar component, and description thereof is omitted appropriately.

First, FIG. 2 indicates the normal operation time. Here, each of the OSC transmitters 32-2 and 32-3 is transmitting an OSC signal with power beyond the safety standard value at the open end of an optical fiber (“N” in the to diagram).

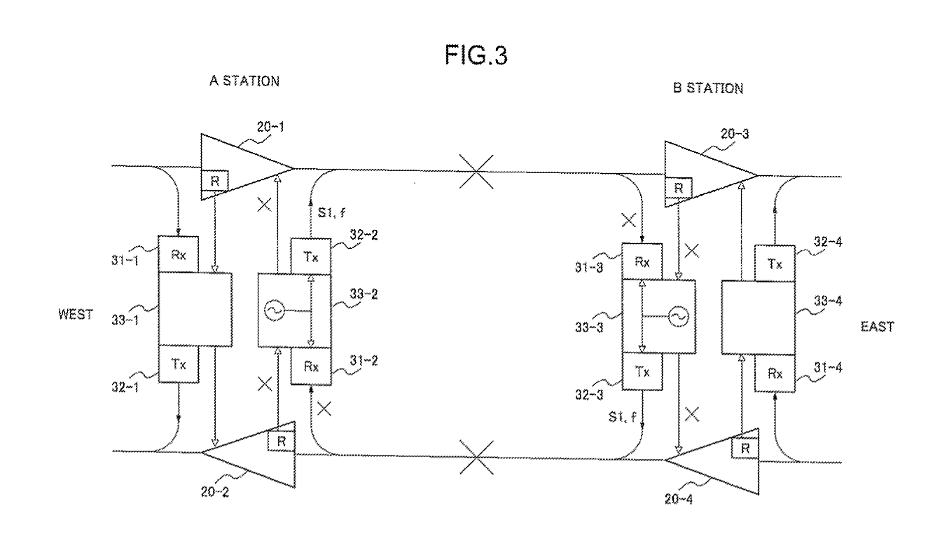

FIG. 3 indicates operation of the optical transmission system according to this embodiment when lines are cut. In FIG. 3, the two lines of a West to East and an East to West are cut. The OSC transmitters 32-2 and 32-3 are transmitting a connection confirmation signal based on an inner free-running oscillator with power below the safety standard value. (“S1, f” in the diagram. Here, “S” shows a connection confirmation signal and “f” shows that it is based on a free-running oscillator.)

Henceforth, operation after the connection is recovered by a maintenance person is indicated in time series.

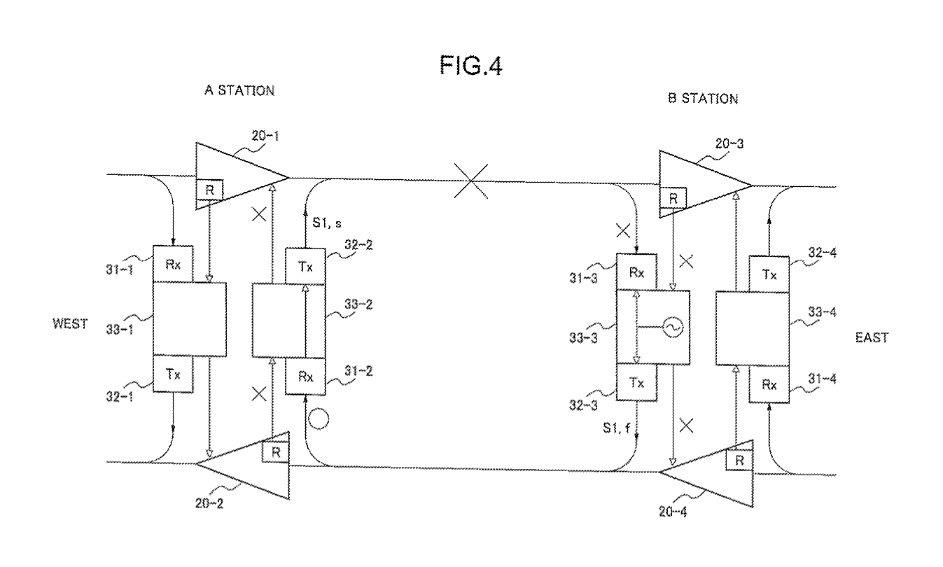

FIG. 4 indicates a case when the connection of one direction (the East to West in the figure) has been recovered. The OSC receiver 31-2 has detected a connection confirmation signal (S1, f) from the OSC transmitter 32-3, and the OSC transmitter 32-2 is transmitting a connection confirmation signal (“S1, s” in the figure) which is synchronized with the signal clock of the connection confirmation signal (S1, f). Here, “s” shows that it is a signal synchronized with a received signal.

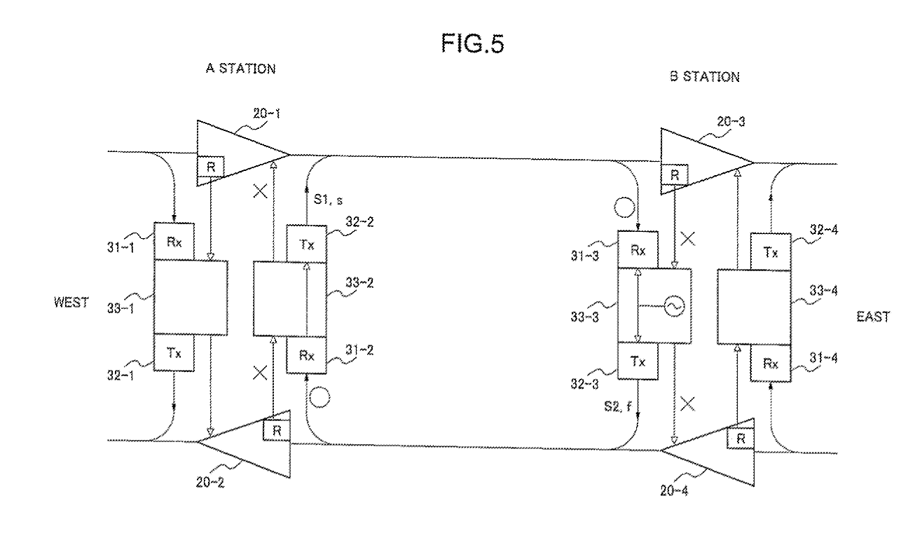

Next, FIG. 5 indicates a case when the connections of both directions have been recovered. OSC receiver 31-3 detects a connection confirmation signal (S1, s), and the OSC transmitter 32-3 transmits S2, f signal the pattern of which (or the phase of which) is different from the aforementioned S1, f.

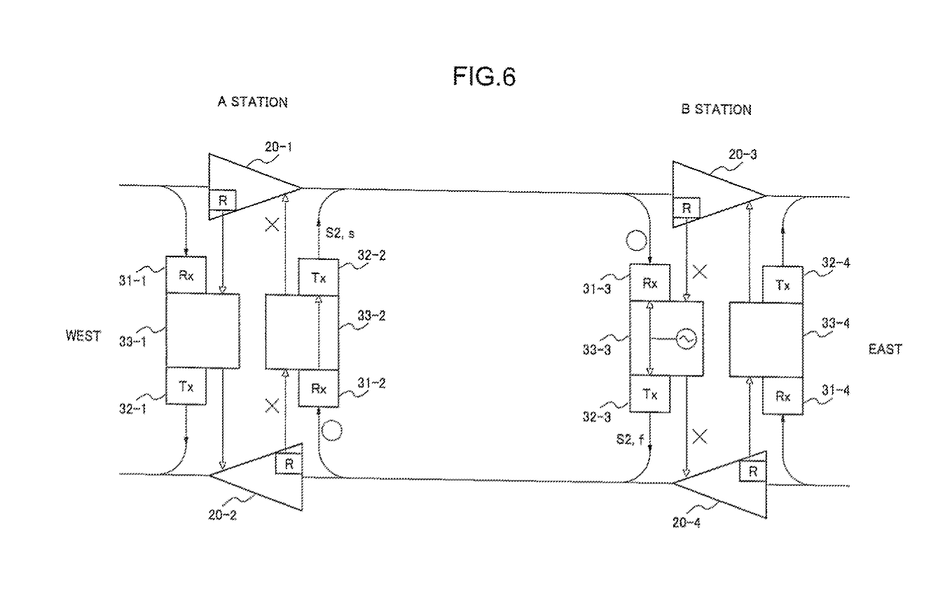

Next, in FIG. 6, because the OSC receiver 31-2 has detected the connection confirmation signal (S2, f), the A station side finds that the OSC line has been restored in both directions and the OSC transmitter 32-2 changes a connection confirmation signal to S2, s signal and transmits it. The receiver 31-3 detects this, and the B station side also finds that the OSC line has been restored in the both directions.

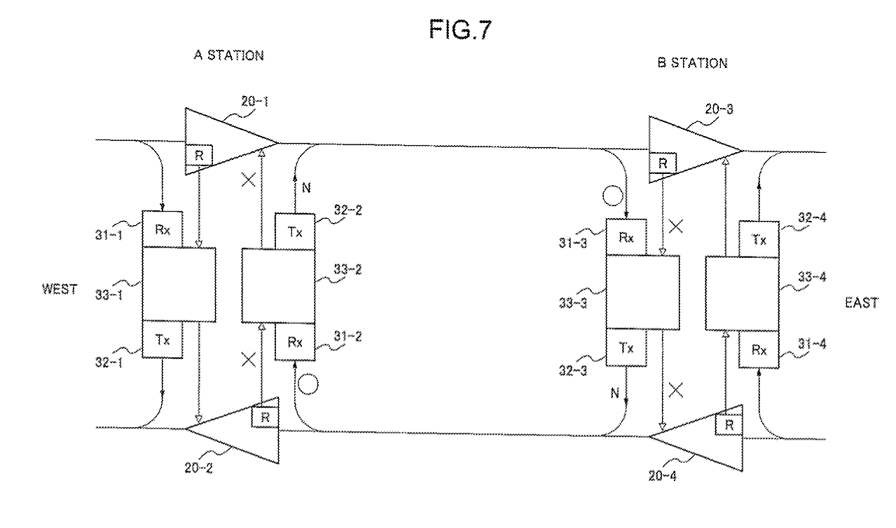

Next, FIG. 7 indicates the state in which OSC communication has returned normal, first, by restoration of the OSC line.

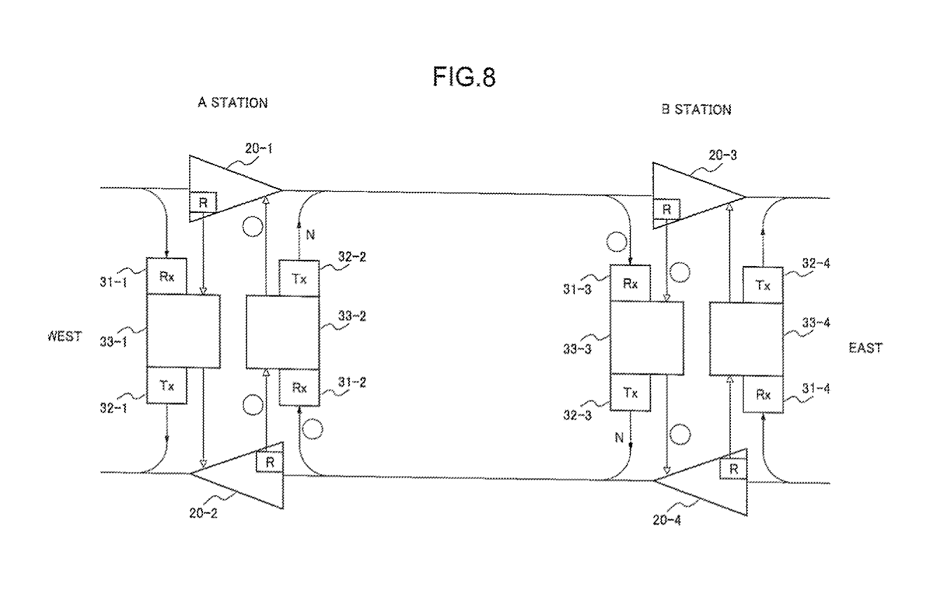

Next, FIG. 8 indicates the state in which the main signal communication has also returned normal by restoration of the line.

Meanwhile, in each step of the link establishment procedure, when it is not possible to advance to the next step on the way, the same step is carried out once again after a given time has expired.

As mentioned above, in this embodiment, its feature exists in a point that connection confirmation is performed first in the OSC connection confirmation mode, and then the OSC normal mode is re-opened, and after that, re-opening of a main signal is performed.

In the connection confirmation mode, because an information transfer rate becomes low compared with the normal communication mode, it is desirable to specify information to be transmitted prior to other in the connection confirmation mode in advance.

### Effect of the Second Embodiment

Next, the effect of this embodiment will be described.

According to this embodiment, in the connection confirmation mode, a signal of short pulse is transmitted with a transmission rate lower than that of the normal communication state at the transmission end of an OSC signal. At the receiving end of an OSC signal, it is possible to detect a received signal sensitively by performing synchronous detection (lock-in detection) of the received signal using an inner oscillator to transmit the signal. For this reason, reception becomes possible even for lower time average receiving light power than that of the first embodiment.

Meanwhile, as a modification, an OSC transmitter and a receiver for connection confirmation and an OSC transmitter and a receiver for the normal state may be separated physically, and they may transmit at the same time by wavelength multiplexing. Further, instead of changing a mode of OSC, an OSC transmitter for connection confirmation may always be in the transmission state, and a transmitter for normal OSC communication may stop and restart transmission according to need.

As another method for making possible to receive an OSC signal even for lower time average receiving light power in the connection confirmation mode, spread spectrum can also be considered.

The spread spectrum method does not change a bit rate from the normal communication mode while an actual transmission rate declines. Coding for the spread spectrum is performed at a transmission end and a receiving end using random patterns which have low correlation each other as a spreading code, and an original signal is transmitted restored with its correlation measured at the receiving end.

Also, an OSC and a main signal may propagate in the same direction or opposite direction. While the case of the same direction has been described in this embodiment, the same mechanism also applies to the case of the opposite direction, and it is needless to say that it has the similar effect.

### The Third Embodiment

A transmitter of the third embodiment of the present invention includes the normal communication mode and the connection confirmation mode. In the normal communication mode, a transmitter transmits an OSC signal with time average power beyond predetermined upper limit power. On the other hand, in the connection confirmation mode, the transmitter transmits an OSC signal with time average power lower than the predetermined upper limit power and with a transmission rate lower than the transmission rate in the normal communication mode.

A transmitter of the third exemplary embodiment usually transmits an OSC signal in the normal communication mode, and transmits an OSC signal in the connection confirmation mode at the time of a failure. Accordingly, without shortening the transmission distance of an OSC signal at the time of a failure, a transmitter of the third exemplary embodiment can lower transmission power of an OSC signal to the regulation value or less at the time of a failure. As a result, the transmitter of the third exemplary embodiment makes possible to restore a line automatically at the time of a failure.

Meanwhile, in the first to third exemplary embodiments described above, control of at least one of a transmitter and a receiver may be performed by a computer. Also, a computer may control one or both of a transmitter and a receiver by a program which has been read from a recording medium in which the program is recorded. A computer may be provided in any one of a transmitter, a receiver and a control unit controlling them.

In an optical transmission apparatus related to the present application, when the amount of information of an OSC signal increases, there is also a problem that transmission power of an OSC signal in the normal state may exceed the safety standard. In such case, there is also a problem that, because transmission power of an OSC signal needs to be lowered to a safe transmission level, even after a line is restored, an OSC signal cannot be received and automatic recovery is not possible any more.

While the invention has been particularly shown and described with reference to exemplary embodiments thereof, the invention is knot limited to these embodiments. It will be understood by those of ordinary skill in the art that various changes in form and details may be made therein without departing from the spirit and scope of the present invention as defined by the claims.

The whole or part of the exemplary embodiments disclosed above can be described as, but not limited to, the following supplementary notes.

(Supplementary Note 1) A transmission unit, operating in one of modes including a normal communication mode and a connection confirmation mode, wherein

said transmission unit transmits, in said normal communication mode, an OSC (Optical Supervisory Channel) signal with time average power beyond predetermined upper limit power; and wherein

said transmission unit transmits, in said connection confirmation mode, said OSC signal with time average power lower than said upper limit power and with a transmission rate lower than a transmission rate in said normal communication mode.

(Supplementary Note 2) The transmission unit according to Supplementary Note 1, wherein

said upper limit power is specified based on a safety standard of said OSC signal applied to said transmission unit.

(Supplementary Note 3) An optical transmission apparatus, comprising:

a transmission unit according to Supplementary Note 1;

a receiving unit which receives an OSC signal from another transmission unit connected to said receiving unit; and

a control unit which operates in one of modes including a normal communication mode and a connection confirmation mode, controls said transmission unit such that an OSC signal is transmitted with time average power beyond predetermined upper limit power in said normal communication mode, and controls said transmission unit such that said OSC signal is transmitted with time average power lower than said predetermined upper limit power and with a transmission rate lower than a transmission rate in said normal communication mode in said connection confirmation mode.

(Supplementary Note 4) The optical transmission apparatus according to Supplementary Note 3, wherein

said control unit controls, in said connection confirmation mode, said receiving unit such that receiving sensitivity of said receiving unit becomes higher than receiving sensitivity in said normal communication mode.

(Supplementary Note 5) The optical transmission apparatus according to Supplementary Note 4, wherein

said control unit narrows, in said connection confirmation mode, a low pass filter band of said receiving unit.

(Supplementary Note 6) The optical transmission apparatus according to Supplementary Note 4, wherein

said control unit narrows a low pass filter band of said receiving unit and reduces a width of a transmission pulse to less than a half of a symbol width.

(Supplementary Note 7) The optical transmission apparatus according to Supplementary Note 4, wherein

said control unit controls, in said connection confirmation mode, such that coding is performed using a random pattern which has low correlation with a random pattern of a counterpart as a spreading code, and an original signal is transmitted and restored by measuring correlation at a receiving end.

(Supplementary Note 8) The optical transmission apparatus according to Supplementary Note 4, said optical transmission apparatus further comprising a synchronous detection unit, wherein

said control unit, in said connection confirmation mode, controls said transmission unit such that said OSC signal is transmitted with a transmission rate lower than a transmission rate in a normal communication state, and controls said receiving unit such that said OSC signal is detected by performing synchronous detection using said synchronous detection unit to transmit a signal, and wherein

said synchronous detection unit presumes said OSC signal by measuring a received waveform by a sampling clock that has a frequency identical with a transmission clock of said transmission unit and a phase noncorrelated to said transmission clock and finding a feature of a code pattern of said OSC signal by accumulating measured values in a memory corresponding to a length of said code pattern.

(Supplementary Note 9) The optical transmission apparatus according to Supplementary Note 3, wherein said optical transmission apparatus confirms connection in said connection confirmation mode, then, restarts said normal communication mode, and after that, restarts transmission of a main signal multiplexed with said OSC signal.

(Supplementary Note 10) The optical transmission apparatus according to Supplementary Note 3, wherein

transmission of information specified in advance is given priority in said connection confirmation mode.

(Supplementary Note 11) An OSC transmission method, comprising the steps of:

transmitting, in a normal communication mode, an OSC signal with time average power beyond predetermined upper limit power; and

transmitting, in a connection confirmation mode, said OSC signal with time average power lower than said upper limit power and with a transmission rate lower than a transmission rate in said normal communication mode.

(Supplementary Note 12) A communication control method, comprising the steps of:

controlling, in a normal communication mode, a transmission unit such that an OSC signal is transmitted with time average power beyond predetermined upper limit power; and

controlling, in a connection confirmation mode, said transmission unit such that said OSC signal is transmitted with time average power lower than said predetermined upper limit power and with a transmission rate lower than a transmission rate in said normal communication mode.

(Supplementary Note 13) The communication control method according to Supplementary Note 12, said method further comprising a step of:

controlling, in said connection confirmation mode, a receiving unit which receives said OSC signal such that receiving sensitivity of said receiving unit becomes higher than receiving sensitivity in said normal communication mode.

(Supplementary Note 14) The communication control method according to Supplementary Note 13, said method further comprising a step of:

narrowing in said connection confirmation mode, a low pass filter band at a time of receiving said OSC signal.

(Supplementary Note 15) The communication control method according to Supplementary Note 13, said method further comprising the steps of:

narrowing a low pass filter band at a time of receiving said OSC signal; and

reducing a width of a transmission pulse narrow to less than a half of a symbol width.

(Supplementary Note 16) The communication control method according to Supplementary Note 13, said method further comprising a step of:

controlling, in said connection confirmation mode, said transmission unit and said receiving unit such that coding is performed using a random pattern which has low correlation with a random pattern of a counterpart as a spreading code, and an original signal is transmitted while restoring said original signal by measuring correlation at a receiving end.

(Supplementary Note 17) The communication control method according to Supplementary Note 13, said method further comprising a step of:

in said connection confirmation mode,

presuming said OSC signal by measuring a received waveform by a sampling clock that has a frequency identical with that of a transmission clock of said OSC signal and a phase noncorrelated to said transmission clock and finding a feature of a code pattern of said OSC signal by accumulating measured values in a memory corresponding to a length of said code pattern.

(Supplementary Note 18) The communication control method according to Supplementary Note 13, said method further comprising the steps of:

confirming connection in said connection confirmation mode; then, re-opening said normal communication mode; and after that, re-opening a main signal which is transmitted in a form being multiplexed with said OSC signal.

(Supplementary Note 19) The communication control method according to Supplementary Note 12, wherein

information transmitted in said connection confirmation mode is specified in advance, and transmission of said information is given priority.

(Supplementary Note 20) A tangible computer-readable program storage medium tangibly embodying a program of a control unit for making a computer of said control unit operating in one of modes including a normal communication mode and a connection confirmation mode carry out processing of:

controlling, in said normal communication mode, a transmission unit such that an OSC signal is transmitted with time average power beyond predetermined upper limit power; and

controlling, in said connection confirmation mode, said transmission unit such that said OSC signal is transmitted with time average power lower than said predetermined upper limit power and with a transmission rate lower than a transmission rate in said normal communication mode.

(Supplementary Note 21) The program storage medium according to Supplementary Note 20, wherein

said program stored in said program storage medium further makes, in said connection confirmation mode, said control unit computer execute control by which receiving sensitivity of a receiving unit that receives said OSC signal becomes higher than receiving sensitivity in said normal communication mode.

(Supplementary Note 22) The program storage medium according to Supplementary Note 20, wherein

said program stored in said program storage medium further makes said control unit computer execute, in said connection confirmation mode, control by which a low pass filter band of a receiving unit that receives said OSC signal is narrowed.

(Supplementary Note 23) The program storage medium according to Supplementary Note 20, wherein

said program stored in said program storage medium further makes said control unit computer execute control by which a low pass filter band of a receiving unit which receives said OSC signal is narrowed and a width of a transmission pulse is narrowed to less than a half of a symbol width.

(Supplementary Note 24) The program storage medium according to Supplementary Note 20, wherein

said program stored in said program storage medium further makes said control unit computer execute, in said connection confirmation mode, control by which coding is performed using a random pattern which has low correlation with a random pattern of a counterpart as a spreading code, and an original signal is transmitted while restoring said original signal by measuring correlation at a receiving end.

(Supplementary Note 25) The program storage medium according to Supplementary Note 20, wherein

said program stored in said program storage medium makes said control unit computer execute: in said connection confirmation mode, control by which, at a transmission end of said OSC signal, said OSC signal is transmitted with a transmission rate lower than a transmission rate in a normal communication state, and, at receiving end of said OSC signal, said OSC signal is detected by making said optical transmission apparatus execute synchronous detection processing for performing synchronous detection and by performing synchronous detection by said synchronous detection processing; and

control by which, in said synchronous detection processing, a transmission code is presumed by: measuring a received waveform by a sampling clock that has a frequency identical with that of a transmission clock of said OSC signal and a phase noncorrelated to said transmission clock; and finding a feature of a code pattern by accumulating measured values in a memory corresponding to a length of said code pattern.

(Supplementary Note 26) The program storage medium according to Supplementary Note 20, wherein

said program stored in said program storage medium makes said control unit computer execute control by which: connection is confirmed in said connection confirmation mode; next, said normal communication mode is re-opened; and after that, a main signal which is transmitted in a manner being multiplexed with said OSC signal is re-opened.

(Supplementary Note 27) The program storage medium according to Supplementary Note 20, wherein

said program stored in said program storage medium makes said control unit computer execute control by which information transmitted by said connection confirmation mode is specified in advance, and transmission of said information is given priority.

(Supplementary Note 28) A transmission unit, operating in one of modes including a normal communication mode and a connection confirmation mode comprising;

a transmission means for transmitting, in said normal communication mode, an OSC (Optical Supervisory Channel) signal with time average power beyond predetermined upper limit power; and

a transmitting means for transmitting, in said connection confirmation mode, said OSC signal with time average power lower than said upper limit power and with a transmission rate lower than a transmission rate in said normal communication mode.

1. A transmission unit, operating in one of modes including a normal communication mode and a connection confirmation mode, wherein
said transmission unit transmits, in said normal communication mode, an OSC (Optical Supervisory Channel) signal with time average power beyond predetermined upper limit power; and wherein
said transmission unit transmits, in said connection confirmation mode, said OSC signal with time average power lower than said upper limit power and with a transmission rate lower than a transmission rate in said normal communication mode.

2. The transmission unit according to claim 1, wherein
said upper limit power is specified based on a safety standard of said OSC signal applied to said transmission unit.

3. An optical transmission apparatus, comprising:
a transmission unit according to claim 1;
a receiving unit which receives an OSC signal from another transmission unit connected to said receiving unit; and
a control unit which operates in one of modes including a normal communication mode and a connection confirmation mode, controls said transmission unit such that an OSC signal is transmitted with time average power beyond predetermined upper limit power in said normal communication mode, and controls said transmission unit such that said OSC signal is transmitted with time average power lower than said predetermined upper limit power and with a transmission rate lower than a transmission rate in said normal communication mode in said connection confirmation mode.

4. The optical transmission apparatus according to claim 3, wherein
said control unit controls, in said connection confirmation mode, said receiving unit such that receiving sensitivity of said receiving unit becomes higher than receiving sensitivity in said normal communication mode.

5. The optical transmission apparatus according to claim 4, wherein
said control unit narrows, in said connection confirmation mode, a low pass filter band of said receiving unit.

6. The optical transmission apparatus according to claim 4, wherein
said control unit narrows a low pass filter band of said receiving unit and reduces a width of a transmission pulse to less than a half of a symbol width.

7. The optical transmission apparatus according to claim 4, wherein
said control unit controls, in said connection confirmation mode, such that coding is performed using a random pattern which has low correlation with a random pattern of a counterpart as a spreading code, and an original signal is transmitted and restored by measuring correlation at a receiving end.

8. The optical transmission apparatus according to claim 4, said optical transmission apparatus further comprising a synchronous detection unit, wherein
said control unit, in said connection confirmation mode, controls said transmission unit such that said OSC signal is transmitted with a transmission rate lower than a transmission rate in a normal communication state, and controls said receiving unit such that said OSC signal is detected by performing synchronous detection using said synchronous detection unit to transmit a signal, and wherein
said synchronous detection unit presumes said OSC signal by measuring a received waveform by a sampling clock that has a frequency identical with a transmission clock of said transmission unit and a phase noncorrelated to said transmission clock and finding a feature of a code pattern of said OSC signal by accumulating measured values in a memory corresponding to a length of said code pattern.

9. The optical transmission apparatus according to claim 3, wherein said optical transmission apparatus confirms connection in said connection confirmation mode, then, restarts of said normal communication mode, and after that, restarts transmission of a main signal multiplexed with said OSC signal.

10. The optical transmission apparatus according to claim 3, wherein
transmission of information specified in advance is given priority in said connection confirmation mode.

11. A communication control method, comprising the steps of:
controlling, in a normal communication mode, a transmission unit such that an OSC signal is transmitted with time average power beyond predetermined upper limit power; and
controlling, in a connection confirmation mode, said transmission unit such that said OSC signal is transmitted with time average power lower than said predetermined upper limit power and with a transmission rate lower than a transmission rate in said normal communication mode.

12. The communication control method according to claim 11, said method further comprising a step of:
controlling, in said connection confirmation mode, a receiving unit which receives said OSC signal such that receiving sensitivity of said receiving unit becomes higher than receiving sensitivity in said normal communication mode.

13. The communication control method according to claim 12, said method further comprising a step of:
narrowing in said connection confirmation mode, a low pass filter band at a time of receiving said OSC signal.

14. The communication control method according to claim 12, said method further comprising the steps of:
narrowing a low pass filter band at a time of receiving said OSC signal; and
reducing a width of a transmission pulse narrow to less than a half of a symbol width.

15. The communication control method according to claim 12, said method further comprising a step of:
controlling, in said connection confirmation mode, said transmission unit and said receiving unit such that coding is performed using a random pattern which has low correlation with a random pattern of a counterpart as a spreading code, and an original signal is transmitted while restoring said original signal by measuring correlation at a receiving end.

16. The communication control method according to claim 12, said method further comprising a step of:
in said connection confirmation mode,
presuming said OSC signal by measuring a received waveform by a sampling clock that has a frequency identical with that of a transmission clock of said OSC signal and a phase noncorrelated to said transmission clock and finding a feature of a code pattern of said OSC signal by accumulating measured values in a memory corresponding to a length of said code pattern.

17. The communication control method according to claim 11, said method further comprising the steps of:
confirming connection in said connection confirmation mode; then, re-opening said normal communication mode; and after that, re-opening a main signal which is transmitted in a form being multiplexed with said OSC signal.

18. The communication control method according to claim 11, wherein
information transmitted in said connection confirmation mode is specified in advance, and transmission of said information is given priority.

19. A tangible computer-readable program storage medium tangibly embodying a program of a control unit for making a computer of said control unit operating in one of modes including a normal communication mode and a connection confirmation mode carry out processing of:
controlling, in said normal communication mode, a transmission unit such that an OSC signal is transmitted with time average power beyond to predetermined upper limit power; and
controlling, in said connection confirmation mode, said transmission unit such that said OSC signal is transmitted with time average power lower than said predetermined upper limit power and with a transmission rate lower than a transmission rate in said normal communication mode.
